(19) United States
(12) Patent Application Publication
(10) Pub. No.: US 2023/0386346 A1
(43) Pub. Date: Nov. 30, 2023

(54) AIRCRAFT FLIGHT MANAGEMENT SYSTEMS AND METHODS

(71) Applicant: THE BOEING COMPANY, CHICAGO, IL (US)

(72) Inventors: Samantha Schwartz, Castle Pines, CO (US); Millie Irene Sterling, Neu-Isenburg (DE); Theresa Emsbach, Neu-Isenburg (DE); Brian Azcuenaga, Centenial, CO (US); Jeffrey Lee Williams, Englewood, CO (US); Aaron Pilcher, Englewood, CO (US)

(73) Assignee: THE BOEING COMPANY, CHICAGO, IL (US)

(21) Appl. No.: 17/825,195

(22) Filed: May 26, 2022

(51) Int. Cl. G08G 5/00; G01C 21/20

(52) U.S. Cl. CPC G08G 5/0039; G08G 5/0021; G01C 21/20; G06F 3/0482

(57) ABSTRACT

A system and a method include a rerouting control unit configured to generate one or more reroute options for an aircraft based on an analysis of a current position of the aircraft, a predicted future position of the aircraft, a current position of an in-flight hazard, a predicted future position of the in-flight hazard, and one or both of: (i) a flight path of one or more other aircraft within an airspace, or (ii) one or both of a minimum amount of fuel of the aircraft or a minimum weight of the aircraft at a destination location.

### FIELD OF THE DISCLOSURE

Examples of the present disclosure generally relate to aircraft flight management systems and methods, and more particularly to systems and methods for predicting and communicating various aspects of flight plans and/or flight plan diversion options for aircraft within an airspace.

### BACKGROUND OF THE DISCLOSURE

Various types of aircraft are used to transport passengers and cargo between various locations. Each aircraft typically flies between different locations according to a defined flight plan or path. For example, a dispatcher may determine a particular flight plan for an aircraft between two different locations.

During a flight, a pilot may decide to divert from a current or original flight plan. For example, hazardous weather (such as a thunderstorm) that is ahead of an aircraft within the current flight plan may prompt a pilot to divert from the current flight plan to avoid the hazardous weather. As another example, air turbulence that is ahead of the aircraft within the original flight plan may also cause the pilot to divert from the current flight plan.

Typically, when a pilot diverts an aircraft from a current flight plan into a different heading, the pilot is not aware of an amount of fuel the aircraft will have at a landing destination until the aircraft links back into the original flight plan, or the pilot receives an updated flight plan using a current position. As such, upon diverting from the original flight plan, the pilot may not be fully confident that the fuel onboard the aircraft at the landing destination will be within a predetermined safe range. That is, the pilot may be required to declare that the aircraft at the landing destination has a predetermined minimum remaining amount of fuel, but may not be sure that such declaration may be made due to the length of the diversion.

Further, rejoining the original route from a diversion may not provide an efficient path to the landing destination. For example, the diversion path may be sufficiently far away from the original flight plan that linking back up to the original flight plan may burn more fuel than another route into the landing destination.

### SUMMARY OF THE DISCLOSURE

A need exists for a system and a method of accurately predicting and communicating various flight path aspects of an aircraft, such as one that has diverted from an original flight plan. Further, a need exists for a system and a method of allowing a pilot to assess how much fuel an aircraft will have at a destination before and/or after diverting from a flight plan. Moreover, a need exists for a system and a method that provide flight plan and/or flight path diversion options to a pilot.

With those needs in mind, certain examples of the present disclosure provide a system including a rerouting control unit configured to generate one or more reroute options for an aircraft based on an analysis of a current position of the aircraft, a predicted future position of the aircraft, a current position of an in-flight hazard, a predicted future position of the in-flight hazard, and one or both of: (i) a flight path of one or more other aircraft within an airspace, or (ii) one or both of a minimum amount of fuel of the aircraft or a minimum weight of the aircraft at a destination location.

In at least one example, the rerouting control unit determines that each of the one or more reroute options does not interfere with the flight path of the one or more other aircraft within the airspace.

In at least one example, the in-flight hazard is one or more of a weather cell as tracked by a weather tracking sub-system in communication with the rerouting control unit, air turbulence as tracked by an air turbulence tracking sub-system in communication with the rerouting control unit, or restricted airspace as tracked by a restricted airspace tracking sub-system in communication with the rerouting control unit.

In at least one example, the system also includes a user interface onboard the aircraft. The rerouting control unit is configured to show the one or more reroute options on the user interface to allow a pilot to select the one or more reroute options.

In at least one example, the aircraft is configured to be automatically operated according to a selected one of the one or more reroute options.

In at least one example, the one or more reroute options include a plurality of reroute options. For example, the plurality of reroute options can include at least two of a turbulence avoidance reroute option, a severe weather avoidance reroute option, a shortest time to destination reroute option, and a least fuel burn reroute option. In at least one example, the rerouting control unit is configured to assess each of the plurality of reroute options in relation to each of the other of the plurality of reroute options.

In at least one example, the rerouting control unit is or is part of an artificial intelligence or machine learning system.

Certain examples of the present disclosure provide a method including generating, by a rerouting control unit, one or more reroute options for an aircraft based on an analysis of a current position of the aircraft, a predicted future position of the aircraft, a current position of an in-flight hazard, a predicted future position of the in-flight hazard, and one or both of: (i) a flight path of one or more other aircraft within an airspace, or (ii) one or both of a minimum amount of fuel of the aircraft or a minimum weight of the aircraft at a destination location.

### BRIEF DESCRIPTION OF THE DRAWINGS

FIG. 1 is a schematic block diagram of a flight plan diversion prediction system in communication with a flight management system and one or more aircraft within an airspace, according to an example of the present disclosure.

FIG. 2 is a diagrammatic representation of a front view of a monitor of a flight plan diversion prediction system, according to an example of the present disclosure.

FIG. 3 is a diagrammatic representation of a front view of a monitor of a flight plan diversion prediction system, according to an example of the present disclosure.

FIG. 4 is a diagrammatic representation of a front view of a user interface, according to an example of the present disclosure.

FIG. 5 illustrates a flow chart of an aircraft management method, according to an example of the present disclosure.

FIG. 6 is a diagrammatic representation of a front perspective view of an aircraft, according to an example of the present disclosure.

### DETAILED DESCRIPTION OF THE DISCLOSURE

The foregoing summary, as well as the following detailed description of certain examples will be better understood when read in conjunction with the appended drawings. As used herein, an element or step recited in the singular and preceded by the word “a” or “an” should be understood as not necessarily excluding the plural of the elements or steps. Further, references to “one example” are not intended to be interpreted as excluding the existence of additional examples that also incorporate the recited features. Moreover, unless explicitly stated to the contrary, examples “comprising” or “having” an element or a plurality of elements having a particular condition can include additional elements not having that condition.

Examples of the present disclosure provide systems and method that allow an aircraft to be rerouted around a predicted hazard (for example, weather, air turbulence, restricted airspace, and/or the like) such as through an optimized route to a destination from a specified clear point. The clear point is a point in which, if remaining on an active selected heading, the prediction location of the aircraft at a future time is past a hazard at the future time. In at least one example, information such as weight of the aircraft, fuel burn, predicted fuel and time over waypoints, and calculated wind from a flight management system can be used to calculate multiple optimized route options for an aircraft. The rerouted path can rejoin the original flight path at a point beyond the predicted hazard, or provide an entirely new path to the destination. Reroute options may be optimized for one or more criteria including (but not limited to) estimated time of arrival, estimated time enroute, fuel burn, ride quality (for example, factoring in air turbulence), and/or likelihood of traffic delays. Providing a clear point in relation to a diversion ensures that there will be no discontinuity in flight management, so a pilot will always have predicted fuel, even during a diversion, and also provides a point in future time and space from which an entirely new route may be calculated. Examples of the present disclosure provide a pilot with graphical tools that allow a tactical reroute.

In at least one example, the systems and methods provide a pilot the option to choose from various heading diversions, for which each option will have a calculated change in fuel and time, based off predicted weather, for example, in correlation with each heading. Once a heading is selected, the clear point can be sent to a flight management system, and provide a pilot-defined waypoint before diverting back to the originally filed flight plan. This allows the flight management system to predict fuel and estimated time of arrival at the destination airport. Once the pilot is clear of the weather, the pilot can use the clear point to calculate the best option back onto the original route, or possibly calculate an entirely new one.

Examples of the present disclosure provide systems and methods for providing optimized route planning around hazards, such as severe weather, for use in flight planning. The systems and methods address the problem of unknown fuel requirements and other flight parameters when a pilot is forced to divert around a hazard, such as severe weather.

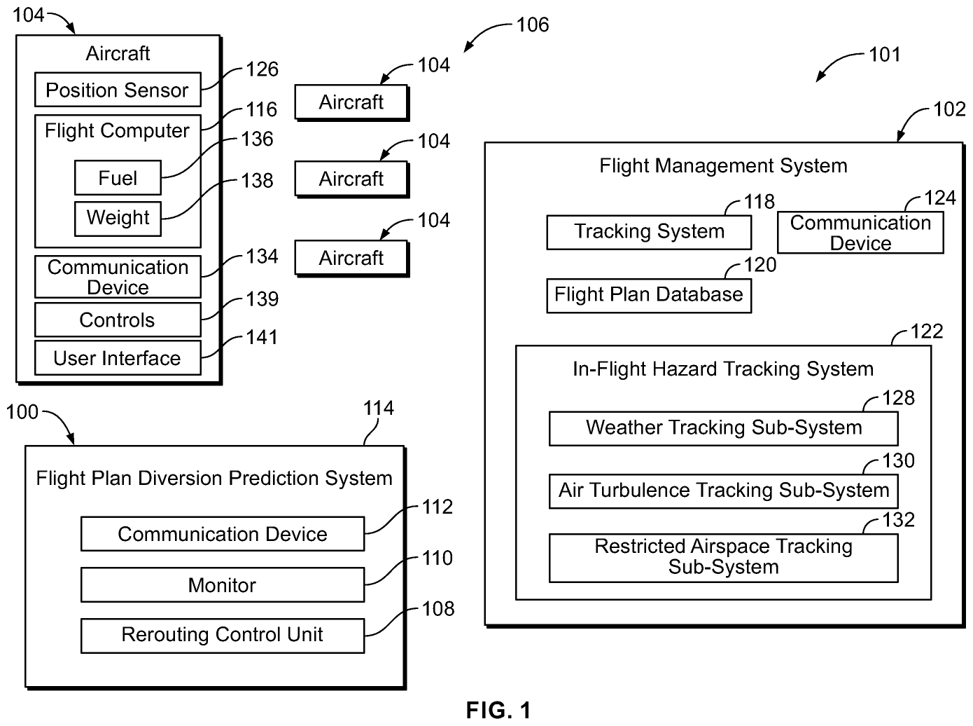

FIG. 1 is a schematic block diagram of a flight plan diversion prediction system 100 in communication with a flight management system 102 and one or more aircraft 104 within an airspace 106, according to an example of the present disclosure. An aircraft management system 101 includes the flight plan diversion prediction system 100, the flight management system 102, and the aircraft 104. The flight plan diversion prediction system 100 includes a rerouting control unit 108 in communication with a monitor 110 and a communication device 112, such as through one or more wired or wireless connections. The monitor 110 may be a display screen, such as a touchscreen display, a computer display screen, a television, and/or the like. The communication device 112 may be or include one or more antennas, radio units, transceivers, receivers, transmitters, and/or the like. The communication device 112 allows the flight plan diversion prediction system 100 to communicate with the flight management system 102 and one or more of aircraft 104 within the airspace 106.

In at least one embodiment, the flight plan diversion prediction system 100 may be contained within a housing 114, such as a computer workstation, a handheld device (such as a smart phone or pad), and/or the like. As shown, the flight plan diversion prediction system 100 may be separate and distinct from the aircraft 104 and the flight management system 102. For example, the flight plan diversion prediction system 100 may be located at a monitoring station (such as at an air traffic control tower, flight operations center, and/or the like) that is remotely located from the aircraft 104.

In at least one other embodiment, the flight plan diversion prediction system 100 may be onboard an aircraft 104. For example, one or more of the aircraft 104 within the airspace 106 may include a flight plan diversion prediction system 100. As an example, a flight computer 116 of an aircraft 104 may include the flight plan diversion prediction system 100. As another example, the flight plan diversion prediction system 100 may be configured to be conveyed into and out of the aircraft 104. For example, the flight plan diversion prediction system 100 may be a separate and distinct computing device (such as a handheld device) of flight personnel, such as a pilot.

The flight management system 102 may be remotely located from the flight plan diversion prediction system 100, or may be collocated with the flight plan diversion prediction system 100. For example, both the flight management system 102 and the flight plan diversion prediction system 100 may be located at a flight operations center, an air traffic control tower, or the like. In at least one embodiment, the flight management system 102 may include the flight plan diversion prediction system 100. As noted, as another option, the flight plan diversion prediction system 100 may be onboard an aircraft 104 or at another location that is remote from the flight management system 102.

The flight management system 102 may include a tracking system 118, a flight plan database 120, an in-flight hazard tracking system 122, and a communication device 124, such as one or more antennas, radio units, transceivers, receivers, transmitters, and/or the like that allow for communication with the flight plan diversion prediction system 100 and the aircraft 104. The flight management system 102 may include the tracking system 118, the flight plan database 120, the in-flight hazard tracking system 122, and the communication device 124 at a common location, such as at a flight operations center or an air traffic control tower. In at least one other embodiment, at least one of the tracking system 118, the flight plan database 120, and the in-flight hazard tracking system 122 may be remotely located from one another.

The tracking system 118 is configured to track positions of the aircraft 104 within the airspace 106. For example, the tracking system 118 can be part of one or more air traffic control facilities, such as can be located at one or more airports. In at least one example, the tracking system 118 is configured to track the flight paths of all of the aircraft 104 within the airspace 106. For example, the airspace 106 can be a predefined area in relation to a destination airport, such as within 100, 200, 500 or more miles of the destination airport. As another example, the airspace can be between departure locations/airports and arrival locations/airports for all the aircraft 104 being tracked by the tracking system 118.

In at least one example, each of the aircraft 104 can include a position sensor 126 that outputs a position signal that is received and tracked by the tracking system 118. In at least one example, the position signal is an automatic dependent surveillance-broadcast (ADS-B) signal and the tracking system 118 is an ADS-B tracking system. The position signal includes one or more position parameters, such as speed, altitude, heading, and the like. In at least one other embodiment, each of the aircraft 104 can be tracked through radar (for example, the tracking system 118 may be or include a radar system).

The flight plan database 120 stores flight plans (which may include future planned routes and/or current or previous actual flight paths flown) for each of the aircraft 104. For example, the flight plan database 120 may store the current flight plan for the aircraft 104. The flight plan database 120 may also store one or more reroute options (to a particular destination) for the aircraft 104, whether or not the reroute options are chosen by a pilot. The flight plans may include original flight plans for the aircraft 104 that include flight paths between departure locations and arrival or destination locations. In at least one other embodiment, each aircraft 104 may include a flight plan database 120, which may store an original flight plan for the aircraft 104 from a departure location to an arrival location. In at least one other embodiment, the flight plan database 120 may be separate and distinct from the flight management system 102.

The in-flight hazard tracking system 122 is configured to track in real time one or more types of in-flight hazards within the airspace 106. The in-flight hazard tracking system 122 includes one or more of a weather tracking sub-system 128, an air turbulence tracking sub-system 130, and a restricted airspace tracking sub-system 132. The in-flight hazard tracking system 122 may be part of the flight management system 102, as shown, or may be remotely located from and in communication with the flight management system 102, such as through one or more communication devices.

The weather tracking sub-system 128 may be any type of system that tracks current weather. For example, the weather tracking sub-system 128 may include a Doppler radar, a weather forecasting service, and/or the like. The weather tracking sub-system 128 is configured to monitor and track weather within the airspace 106 in real time, and may also provide weather predictions for the future.

The air turbulence tracking sub-system 130 is configured to track and/or predict locations of air turbulence within the airspace 106. The air turbulence tracking sub-system 130 may include a reporting service or system that determines locations of air turbulence within the airspace 106, such as through reports from pilots. Optionally, the in-flight hazard tracking system 122 may not include the air turbulence tracking sub-system 130.

The restricted airspace tracking sub-system 132 is configured to track and/or predict locations of restricted airspace within the airspace 106. The restricted airspace tracking sub-system 132 may include a reporting service or system that determines locations of restricted airspace within the airspace 106, such as through airport or governmental notices, reports, and/or the like. Optionally, the in-flight hazard tracking system 122 may not include the restricted airspace tracking sub-system 132.

In at least one embodiment, the weather tracking sub-system 128, the air turbulence tracking sub-system 130, and/or the restricted airspace tracking sub-system 132 are separate, distinct, and remote from the flight management system 102. The weather tracking sub-system 128, the air turbulence tracking sub-system 130, and/or the restricted airspace tracking sub-system 132 may be separately in communication with the flight plan diversion prediction system 100.

The aircraft 104 includes the flight computer 116 and the position sensor 126, as noted above. The aircraft 104 also includes a communication device 134, such as one or more antennas, radio units, transceivers, receivers, transmitters, and/or the like, which allow the aircraft 104 to communicate with the flight plan diversion prediction system 100 and the flight management system 102. The aircraft 104 also includes controls 139 that are configured to control operation of the aircraft 104 so as to fly between a departure location and an arrival location.

The aircraft 104 also includes a user interface 141, such as an electronic monitor and input device, such as a keyboard, a mouse, a stylus, and/or the like. In at least one example the user interface 141 can be a touchscreen interface that is configured to show various options to a pilot, and allow the pilot to select one or more options via touching the screen. In at least one example, the flight computer 116 includes the user interface 141. In at least one other example, the user interface 141 is separate and distinct from the user interface 141.

The flight computer 116 assesses a current amount of fuel 136 and weight 138 of the aircraft 104. The flight computer 116 determines the amount of fuel 136 burned by comparing the total amount of fuel 136 before takeoff to the current level of fuel 136. Further, the flight computer 116 determines a remaining amount of fuel 136 (that is, the current amount of fuel 136 onboard the aircraft 104). Similarly, the flight computer 116 determines the current weight 138 of the aircraft 104, and determines the difference between the current weight 138 and the weight 138 before takeoff.

During a flight, the aircraft 104 may divert from an original flight plan to a diverted flight plan based on an in-flight hazard as determined by the in-flight hazard tracking system 122. Before and/or during diversion from the original flight plan, the rerouting control unit 108 determines one or more rerouting options for the aircraft 104 between a current or future position of the aircraft 104 and the destination location for the aircraft 104. The rerouting control unit 108 can determine a plurality of options based on various parameters. For example, the rerouting control unit 108 can determine a first rerouting option that stays outside of a predetermined distance from the in-flight hazard (such as at least 50 miles or more from the in-flight hazard). As another example, the rerouting control unit 108 can determine a second rerouting option that avoids air turbulence. As another example, the rerouting control unit 108 can determine a third rerouting option that minimizes or otherwise reduced fuel burn. As another example, the rerouting control unit 108 can determine a fourth rerouting option that represents the shortest time to arrival at the destination location. The rerouting control unit 108 can determine more or less rerouting options based on one or more other parameters.

The rerouting control unit 108 can then output a signal including the data regarding the determined rerouting options to the aircraft 104. The rerouting options are then shown on the user interface 141. A pilot can the select one of the rerouting options based on preference (for example, turbulence avoidance, weather avoidance, fuel savings, shortest time, or the like). In at least one example, the pilot selects a particular rerouting option, as determined by the rerouting control unit 108, and the aircraft 104 is automatically operated according to the selected rerouting option. For example, the controls 139 can be automatically controlled according to a flight path set by the selected rerouting option. In this manner, an auto-pilot system of the aircraft 104 can operate the aircraft 104 based on the selected rerouting option, which is presented on the user interface 141, such as by the rerouting control unit 141.

In at least one example, the rerouting control unit 108 determines each of the rerouting options based on air traffic within the airspace 106. For example, the rerouting control unit 108 is in communication with the tracking system 118 (and optionally, the flight plan database 120) to determine traffic of all the aircraft 104 within the airspace 106. The rerouting control unit 108 analyzes the flight paths, whether original or diverted, of each of the aircraft 104 within the airspace 106 to determine if a rerouting option could potentially interfere with the flight path of another aircraft 104, as determined by the tracking system 118 and/or the flight plan database 120. For example, the rerouting control unit 108 can determine a potential conflict with the flight path of another aircraft 104 if a possible rerouting option is within a predetermined distance at a predetermined time. For example, the predetermined distance can be 10 miles or less at a particular time. The rerouting control unit 108 can be programmed based on air traffic control rules and regulations that may prohibit such flight paths. In this manner, if the rerouting control unit 108 determines that a possible reroute option conflicts within a flight path of another aircraft, the rerouting control unit 108 discards the possible reroute option, and does not present such as a reroute option. If, however, the possible reroute option does not conflict with a flight path of another aircraft, the rerouting control unit 108 determines that the possible reroute option is viable, and presents the reroute option on the user interface 141 for possible selection by a pilot of the aircraft 104.

In at least one example, the weather tracking sub-system 128 can detect hazardous weather within the airspace 106. The aircraft 104 can receive the weather report alert from the weather tracking sub-system 128, and the pilot may decide to divert around the weather according to one or more reroute options, as determined by the rerouting control unit 108. As another example, the aircraft 104 may divert from the original flight plan to a diverted plan (as determined by the rerouting control unit 108) due to air turbulence within the airspace 106, as determined by the air turbulence tracking sub-system 130, or a restricted airspace within the airspace 106, as determined by the restricted airspace tracking sub-system 132. Hazardous weather (as detected and/or determined by the weather tracking sub-system 128), air turbulence (as detected and/or determined by the air turbulence tracking sub-system 130), and a restricted airspace (as detected and/or determined by the restricted airspace tracking sub-system 132) are examples of in-flight hazards within the airspace 106 that a pilot may decide to divert around (that is, deviate from a current flight plan to a diverted flight plan to avoid such in-flight hazards), based on one or more reroute options determined by the rerouting control unit 108.

The rerouting control unit 108 analyzes the current position of the aircraft 104. For example, the rerouting control unit 108 detects a current heading, position, and airspeed of the aircraft 104, such as determined by the tracking system 118. The rerouting control unit 108 may also analyze a current location of the in-flight hazard, such as hazardous weather as detected by the weather tracking sub-system 128. The rerouting control unit 108 analyzes the position of the aircraft 104 within the airspace 106, and the in-flight hazard, and determines one or more of the reroute options for the aircraft 104. The reroute options provide one or more diverted flight plan options that connect to a landing location, such as the arrival or destination location within the current or original flight plan. The reroute options may or may not connect back to a point of an original flight plan.

The reroute options include a predicted amount of fuel and weight of the aircraft at the landing location. For example, the rerouting control unit 108 may communicate with the flight computer 116 to determine a current fuel 136 and weight 138 of the aircraft 104 and determine the predicted amount of fuel 136 and weight 138 at the landing location based on the determined reroute path and the current fuel consumption rate (that is, fuel burn) of the aircraft 104. The reroute option(s), including the predicted amount of fuel 136 and the predicted aircraft weight 138 at the landing location, are shown on the monitor 110.

In at least one example, when determining the reroute options, the rerouting control unit 108 assesses the predicted amount of fuel and weight of the aircraft 104 at the landing location. The aircraft 104 may be required to have at least a particular amount of fuel and at least a particular weight upon arrival at the arrival location. The rerouting control unit 108 may receive data including such minimum fuel and weight requirements from the flight computer 116, for example. If a potential reroute option violates such minimum fuel and/or weight requirements, the rerouting control unit 108 discards the potential reroute option, and does not present such on the user interface 141 as a reroute option.

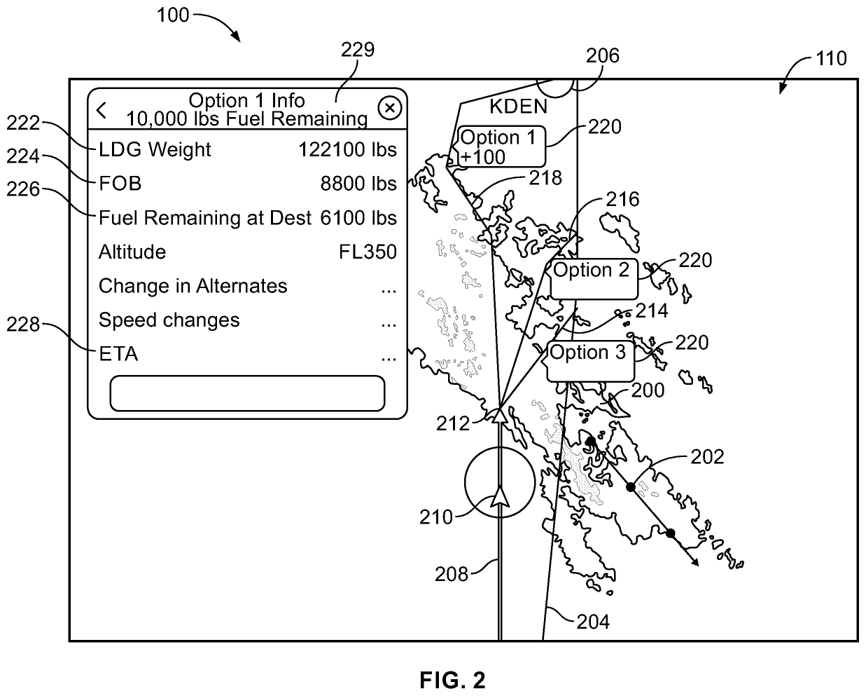

As described herein, a system, such as the aircraft management system 101, includes the rerouting control unit 108 configured to generate one or more reroute options for the aircraft 104 based on an analysis of a current position of the aircraft 104, a predicted future position of the aircraft 104, a current position of an in-flight hazard (such as a weather cell 200, as shown in FIG. 2), a predicted future position of the in-flight hazard, and one or both of: (i) a flight path of one or more other aircraft within the airspace 106, or (ii) one or both of a minimum amount of fuel of the aircraft 104 or a minimum weight of the aircraft 104 at a destination location.

As used herein, the term “control unit,” “central processing unit,” “unit,” “CPU,” “computer,” or the like may include any processor-based or microprocessor-based system including systems using microcontrollers, reduced instruction set computers (RISC), application specific integrated circuits (ASICs), logic circuits, and any other circuit or processor including hardware, software, or a combination thereof capable of executing the functions described herein. Such are exemplary only, and are thus not intended to limit in any way the definition and/or meaning of such terms. For example, the rerouting control unit 108 may be or include one or more processors that are configured to control operation thereof, as described herein.

The rerouting control unit 108 is configured to execute a set of instructions that are stored in one or more data storage units or elements (such as one or more memories), in order to process data. For example, the rerouting control unit 108 may include or be coupled to one or more memories. The data storage units may also store data or other information as desired or needed. The data storage units may be in the form of an information source or a physical memory element within a processing machine.

The set of instructions may include various commands that instruct the rerouting control unit 108 as a processing machine to perform specific operations such as the methods and processes of the various embodiments of the subject matter described herein. The set of instructions may be in the form of a software program. The software may be in various forms such as system software or application software. Further, the software may be in the form of a collection of separate programs, a program subset within a larger program or a portion of a program. The software may also include modular programming in the form of object-oriented programming. The processing of input data by the processing machine may be in response to user commands, or in response to results of previous processing, or in response to a request made by another processing machine.

The diagrams of embodiments herein may illustrate one or more control or processing units, such as the rerouting control unit 108. It is to be understood that the processing or control units may represent circuits, circuitry, or portions thereof that may be implemented as hardware with associated instructions (e.g., software stored on a tangible and non-transitory computer readable storage medium, such as a computer hard drive, ROM, RAM, or the like) that perform the operations described herein. The hardware may include state machine circuitry hardwired to perform the functions described herein. Optionally, the hardware may include electronic circuits that include and/or are connected to one or more logic-based devices, such as microprocessors, processors, controllers, or the like. Optionally, the rerouting control unit 108 may represent processing circuitry such as one or more of a field programmable gate array (FPGA), application specific integrated circuit (ASIC), microprocessor(s), and/or the like. The circuits in various embodiments may be configured to execute one or more algorithms to perform functions described herein. The one or more algorithms may include aspects of embodiments disclosed herein, whether or not expressly identified in a flowchart or a method.

As used herein, the terms “software” and “firmware” are interchangeable, and include any computer program stored in a data storage unit (for example, one or more memories) for execution by a computer, including RAM memory, ROM memory, EPROM memory, EEPROM memory, and non-volatile RAM (NVRAM) memory. The above data storage unit types are exemplary only, and are thus not limiting as to the types of memory usable for storage of a computer program.

FIG. 2 is a diagrammatic representation of a front view of the monitor 110 of the flight plan diversion prediction system 100, according to an example of the present disclosure. The monitor 110 can be onboard the aircraft 104. For example, the user interface 141 can include the monitor 110. Optionally, the rerouting control unit 108 shown in FIG. 2 can show the display, as shown on FIG. 2, on the user interface 141.

Referring to FIGS. 1 and 2, the weather tracking sub-system 128 detects a weather cell 200 having a vector 202 (including airspeed and direction). The flight plan diversion prediction system 100 receives data regarding the weather cell 200 from the weather tracking sub-system 128 and shows the weather cell 200 on the monitor 110. The monitor 110 also shows a portion of an original flight plan 204 (which the flight plan diversion prediction system 100 may receive from the flight plan database 120) to a destination location 206.

As shown, based on the weather cell 200, the aircraft 104 can be diverted into a diverted flight plan 208, such as determined by the rerouting control unit 108. The current position of the aircraft 104 (as detected by the tracking system 118) is shown on the monitor 110 by a current position indicator 210.

A clearpoint 212 is also shown on the monitor 110. The clearpoint 212 is a location on the diverted flight plan 208 at which the aircraft 104 will be clear of the weather cell 200 (or other such in-flight hazard) based on the current course, airspeed and heading at a particular time. In at least one embodiment, a pilot may manually determine and locate the clearpoint 212 along the diverted flight plan 208. As another option, the clearpoint 212 may be determined as a predetermined position along the diverted flight plan, such as a point 10 miles away from the current position of the aircraft 104 as shown by the current position indicator 210 based on the current heading of the aircraft 104 and/or a predetermined future time, such as where the aircraft 104 will be in 5 minutes based on the current heading and airspeed of the aircraft 104.

In at least one other example, the rerouting control unit 108 determines the location of the clearpoint 212. For example, the rerouting control unit 108 may analyze the weather cell 200 and the vector 202 to determine a location of the weather cell 200 at a particular time. The rerouting control unit 108 may compare the predicted location of the weather cell 200 and the vector 202 with the current position (as shown by the current position indicator 210) of the aircraft 104 to determine the clearpoint 212. For example, based on the diverted flight plan 208, the current position of the aircraft 104 along the diverted flight plan 208, the movement of the weather cell 200, and the predicted motion of the weather cell 200 based on the vector 202, the rerouting control unit 108 determines the clearpoint 212. In particular, the rerouting control unit 108 assesses the current position, heading, and airspeed of the aircraft 104 on the diverted flight plan 208 (such as detected by the tracking system 118). The rerouting control unit 108 then compares the current position, heading, and airspeed (and optionally previous position, heading, and airspeed for a predetermined time) of the aircraft 104 with the location of the weather cell 200 and predicted location of the weather cell 200 at a future, later time based on the motion of the weather cell 200 as determined via the vector 202, and determines the location at which the aircraft 104 will be clear of the weather cell 200 at a future, later time (that is, the clearpoint 212).

As described, the clearpoint 212 may be determined and manually picked by a pilot of the aircraft 104, arbitrarily determined by the rerouting control unit 108, and/or dynamically and automatically determined by the rerouting control unit 108, such as based on the current location, heading, and airspeed of the aircraft 104 in relation to the current location and vector 202 of the weather cell 200 (the analysis of which allows the rerouting control unit 108 to predict the future positions of the aircraft 104 and the weather cell 200). After the clearpoint 212 is determined, the rerouting control unit 108 determines one or more reroute options 214, 216, and 218 for the aircraft 104. The reroute options 214, 216, and 218 may link or join back to the original flight plan 204. Optionally, at least one of the reroute options 214, 216, or 218 may not link or join back to the original flight plan 204. For each reroute option, 214, 216, and 218, the rerouting control unit 108 predicts or otherwise determines one or more flight path aspects (such as predicting remaining fuel, weight, or the like) for the aircraft 104 at the destination location 206 (if the aircraft 104 were to fly according to the particular reroute option 214, 216, and 218). The rerouting control unit 108 determines and predicts the flight path aspect(s) based on the current flight path aspect(s) of the aircraft 104 at the current location (such as remaining fuel, current airspeed, and current consumption level of fuel) and the length of the reroute options 214, 216, and 218.

For each reroute option 214, 216, and 218, the rerouting control unit 108 provides a reroute information indicator 220, such as a box or area 229 (which may be expandable, such as through a swipe, slide, tap or the like of a finger, stylus, or the like). An individual may expand the reroute information indicator 220, such as by tapping with a finger (when the monitor is a touchscreen interface, for example), pointing and clicking with an engagement device (such as a stylus or mouse), and/or the like. Each reroute information indicator 220 that may list one or more predicted flight path aspects, such as a predicted landing weight 222, predicted fuel on board (FOB) 224, predicted fuel remaining 226 at the destination, and/or a predicted estimated time of arrival (ETA) 228 at the destination location 206 if the pilot chooses to fly according to a particular reroute option 214, 216, and 218. The reroute information indicator 220 may also include the FOB as of the current time. The pilot may then compare the predicted flight path aspects for each of the reroute options 214, 216, and 218 to make an informed decision as to an efficient and/or safe reroute option 214, 216, or 218 to choose.

As shown in FIG. 2, the rerouting control unit 108 determines and shows three reroute options on the monitor 110. Optionally, the rerouting control unit 108 may determine and show more or less than three reroute options. For example, the rerouting control unit 108 may determine 4 or more reroute options to the destination location 206 from the clearpoint 212.

The rerouting control unit 108 indicates the clearpoint 212 on the monitor 110 and provides one or more reroute options 214, 216, and/or 218, each of which includes reroute information indicator 220 listing one or more flight path aspects, thereby allowing a pilot of the aircraft 104 to know a predicted amount of fuel and weight at the destination location 206. Further, the rerouting control unit 108 provides a point in future time and space (that is, the clearpoint 212) from which a new route (such as the reroute options 214, 216, and 218) are determined. Accordingly, the flight plan diversion prediction system 100 provides a pilot with the ability to perform an informed and tactical flight plan diversion and reroute from the original flight plan 204. The flight plan diversion prediction system 100 allows the pilot to determine a tactical reroute without losing insight into how much fuel will be onboard the aircraft 104 upon landing at the destination location 206.

The reroute options 214, 216, 218 may be received by the flight management system 102, and stored in the flight plan database 120. A reroute option 214, 216, or 218 that is chosen by a pilot may be stored in the flight plan database 120 as an active reroute option. A reroute option 214, 216, or 218 that is not chosen by a pilot may be stored in the flight plan database as an inactive reroute option, or, alternatively discarded.

The reroute options 214, 216, 218 include the clearpoint 212. The reroute options 214, 216, 218 may each start from the clearpoint 212. In at least one other embodiment, each reroute option 214, 216, and 218 may include a separate clearpoint. The reroute options 214, 216, and 218 may or may not begin from a respective clearpoint. For example, each reroute option 214, 216, and 218 may include a diversion point from the flight plan 204, which may or may not be a clearpoint.

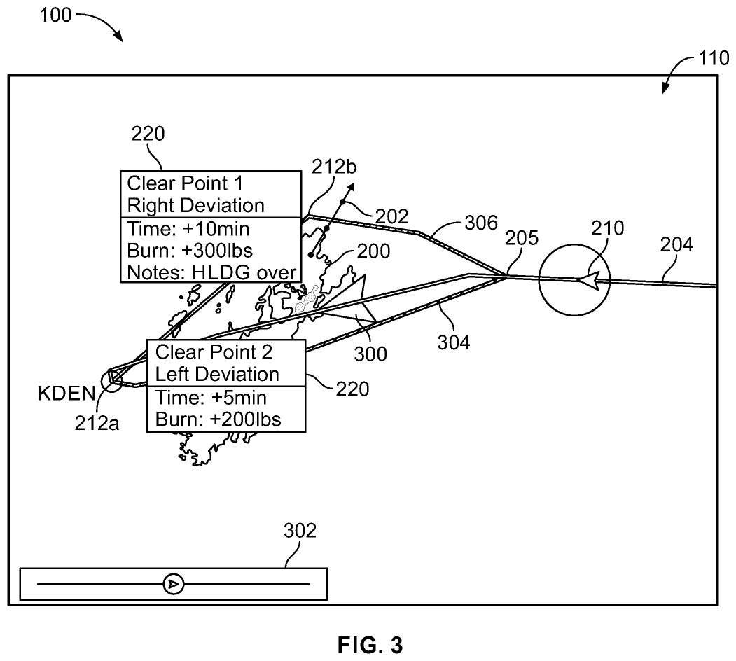

FIG. 3 is a diagrammatic representation of a front view of the monitor 110 of the flight plan diversion prediction system 100, according to an example of the present disclosure. The monitor 110 can be onboard the aircraft 104. For example, the user interface 141 can include the monitor 110. Optionally, the rerouting control unit 108 shown in FIG. 2 can show the display, as shown on FIG. 3, on the user interface 141.

Referring to FIGS. 1 and 3, the current location of an aircraft 104 is shown by current position indicator 210. The current position indicator 210 is along an original flight plan 204. A future point along the original flight plan 204 is shown by a future position indicator 300. The future position indicator 300 is correlated with a predicted position at a future time along the original flight plan 204 if the aircraft 104 continues to fly according to the original flight plan 204. The rerouting control unit 108 shows the predicted position of the weather cell 200 and vector 202 (based on past motion and current position of the weather cell 200) on the monitor 110, and determines a predicted position of the aircraft 104 as indicated by the future position indicator 300 on the original flight plan 204. A time selector 302 (such as a slide bar on a touchscreen interface of the monitor 110) may be operated by an individual to illustrate relative positions of the weather cell 200 and the future position indicator 300. For example, a pilot may see the current position of the weather cell 200, and may move the time selector 302 to a position thirty minutes into the future, at which the rerouting control unit 108 shows the predicted position of the weather cell 200 along with the future position indicator 300 at the selected future time. If the rerouting control unit 108 determines and shows that the aircraft 104 will avoid the predicted position of the weather cell 200 at the selected future time, the pilot may opt to remain on the original fight plan 204.

If, however, the rerouting control unit 108 determines and shows that the aircraft 104 will be within the weather cell 200 at the selected future time, the pilot may choose a diverted flight path. For example, the pilot may choose from a first heading change that provides a first reroute option 304 (showing a first diverted flight path) starting from a diversion point 205 from the flight plan 204, and a second heading change that differs from the first heading change that provides a second reroute option 306 (showing a second diverted flight path) starting from the diversion point 205. Clearpoints 212a and 212b may be determined for each of the reroute options 304 and 306, respectively, as explained above. As shown, each of the first reroute option 304 and the second reroute option 306 includes a separate and distinct clearpoint 212a and 212b, respectively. For each of the reroute options 304 and 306, the rerouting control unit 108 may determine and show on the monitor 110 reroute information indicator 220 that may list one or more predicted flight path aspects. Based on the predicted flight path aspects, as shown in the reroute information indicator 220, the pilot may make an informed decision as to an efficient and/or safe reroute option 304 or 306 to pick. As shown in FIG. 3, the first reroute option 304 may add five minutes of flight time and burn two hundred extra pounds of fuel in relation to the original fight plan 204, while the second reroute option 306 may add ten minutes of flight time and burn three hundred extra pounds of fuel in relation to the original flight plan 204. As such, the pilot may opt for the first reroute option 304 (assuming the first reroute option 304 and the second reroute option 306 are substantially equally as safe), as it takes less total flight time and burns less fuel as compared to the second reroute option 306.

In at least one example, the rerouting control unit 108 may monitor other aircraft 104 that are closer (and/or already landed) to the destination location in addition to monitoring the aircraft 104 indicated at the current position indicator 210. The rerouting control unit 108 may determine the rerouted flight paths chosen by the previous aircraft 104. For example, pilots of one or more previous aircraft 104 may have chosen a rerouted flight path to the North of the weather cell 200, while other aircraft 104 later in time may have chosen a rerouted flight path to the South of the weather cell 200. The rerouting control unit 108 may analyze the previously rerouted flight paths to determine the reroute options 304 and 306, including the diverted flight paths. The rerouting control unit 108 may determine the reroute options 304 and 306 based on weighted averages (such as of actual fuel and weight at the destination location, fuel burn, and/or the like) of the previous rerouted flight paths, for example.

The rerouting control unit 108 of the flight plan diversion prediction system 100 shows tactically on the monitor 110 an efficient (or relatively efficient as compared to others) and/or safe (or relatively safe as compared to others) diverted flight path via a comparison of the reroute options 304 and 306. The rerouting control unit 108 may analyze the flight path data of previous aircraft in front of the aircraft 104 denoted by the current position indicator 210 either in real time or via historical data to predict a time and fuel burn of the aircraft 104 for the reroute options 304 and 306. By having access to real time tracking data (such as through the tracking system 118), the rerouting control unit 108 is able to determine additional time and fuel approximations, and also if additional delays are present such as due to in-flight holding (for example, holding patterns).

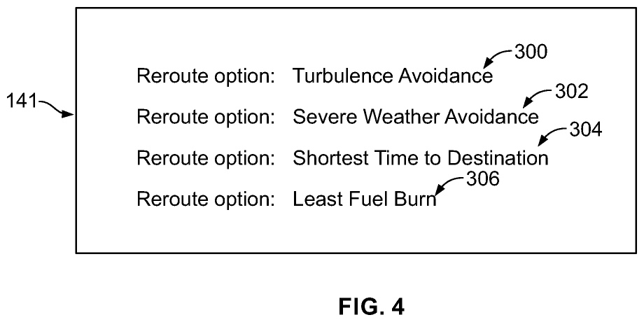

FIG. 4 is a diagrammatic representation of a front view of the user interface 141, according to an example of the present disclosure. Optionally, the monitor 110 (shown in FIG. 1) can show the information as shown in FIG. 4. Referring to FIGS. 1 and 4, the rerouting control unit 108 determines a plurality of reroute options. The rerouting control unit 108 is in communication with the tracking system 118 to ensure that the reroute options do not interfere with flight paths of other aircraft within the airspace 106, as described herein. Additionally, the rerouting control unit 108 is in communication the flight computer 116 of the aircraft 104 to ensure that each of the reroute options conforms to minimum fuel and weight requirements for the aircraft 104 at the destination location.

As shown, the rerouting control unit 108 can determine a plurality of reroute options, such as turbulence avoidance 300, severe weather avoidance 302, shortest time to destination (for example, shorted estimated time of arrival) 304, least amount of fuel burn 306, and/or the like. The rerouting control unit 108 can determine and display more or less reroute options than shown. In at least one example, the rerouting control unit 108 can assess each reroute option in relation to the others. For example, the turbulence avoidance reroute option 300 can be assessed in relation to the least fuel burn reroute option (such as the turbulence reroute option 300 being the second, third, or fourth best option for least fuel burn). As another example, the shortest time to destination reroute option 304 can be assessed as the fourth ranked option in relation to the turbulence avoidance.

In at least one example, each of the reroute options can be assessed in relation to each of the other reroute options, such that each of the reroute options is ranked from 1-4 in relation to each of the reroute options. For example, the reroute option 300 is ranked first for turbulence avoidance, second for severe weather avoidance, third for least fuel burn, and fourth for shortest time to destination. As another example, the reroute option 304 is ranked first for shortest time to destination, second for turbulence avoidance, third for least fuel burn, and fourth for sever weather avoidance. In this manner, a pilot can make an informed decision that factors in all of the various parameters, instead of just picking one that is the best in relation to a single parameter.

The reroute options, as determined by the rerouting control unit 108, can include various other parameters, such as estimated time enroute, shortest distance, longest distance, lowest or highest altitude, and/or the like. It is to be understood that the reroute options shown in FIG. 4 are merely exemplary, and not limiting.

A pilot can select one of the reroute options. In at least one example, in response to selection of a reroute option, the aircraft 104 is automatically (that is, without human intervention) flown to the destination location according to the selected reroute option. For example, the controls 139 are automatically operated, such as by the flight computer 116 and/or the rerouting control unit 108, according to the selected reroute option.

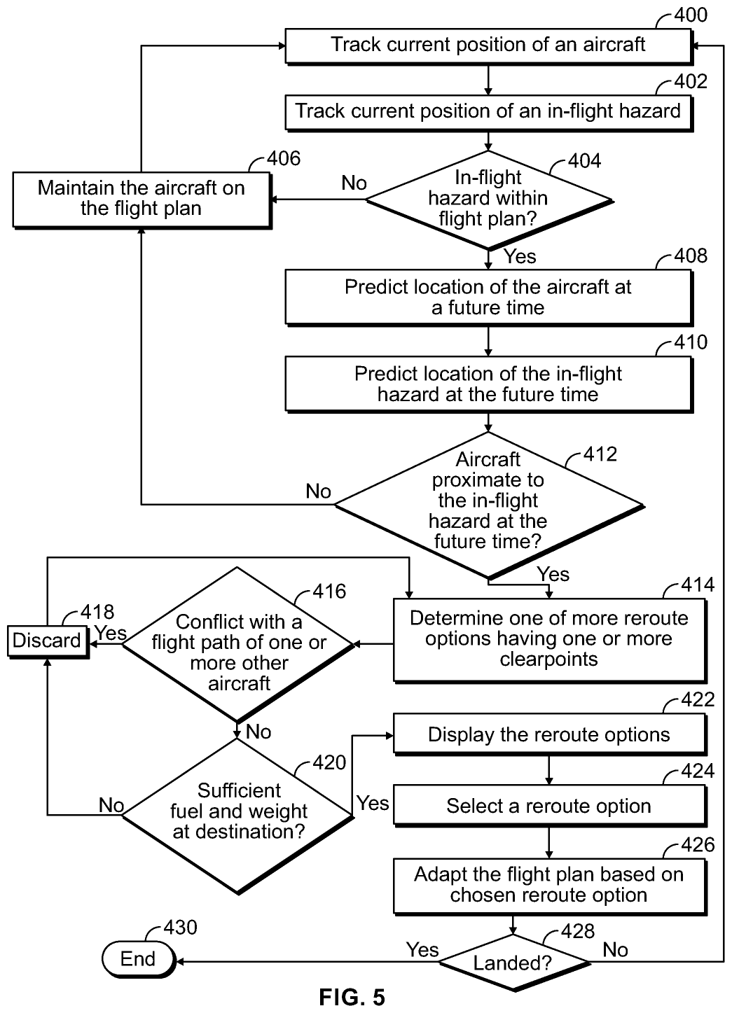

FIG. 5 illustrates a flow chart of an aircraft management method, according to an embodiment of the present disclosure. Referring to FIGS. 1-5, at 400, a current position of an aircraft 104 is tracked, such as via the tracking system 118. At 402, a current position of an in-flight hazard (such as a weather cell, location of air turbulence, or restricted airspace) is tracked, such as via the in-flight hazard tracking system 122.

At 404, the rerouting control unit 108 determines whether the in-flight hazard is (and/or will be) within a current flight plan of the aircraft 104. Optionally, an individual, such as a pilot, may determine whether the in-flight hazard is within the current flight plan. If not, the method proceeds from 404 to 406, at which the aircraft is maintained on the current flight plan, and then the method returns to 400.

If, however, the in-flight hazard is (and/or will be) within the current flight plan, the method proceeds from 404 to 408, at which the rerouting control unit 108 predicts the location of the aircraft 104 at a future time (that is, a time later than the current time). For example, the rerouting control unit 108 may predict the location of the aircraft 104 at the future time by analyzing the past and current position, heading, direction, airspeed and/or the like of the aircraft, and making the prediction of the location of the aircraft based thereon.

At 410, the rerouting control unit 108 predicts a location of the in-flight hazard at the future time. For example, the rerouting control unit 108 may predict the location of the in-flight hazard at the future time by analyzing the past and current position and vector of the in-flight hazard, and making the prediction of the location of the in-flight hazard based thereon.

At 412, the rerouting control unit 108 determines whether the aircraft 104 will be proximate to (for example, at and/or within a predetermined range) the in-flight hazard at the future time, based on the predicted location of the aircraft 104 and the predicted location of the in-flight hazard at the future time. If the aircraft 104 will not be proximate to the in-flight hazard at the future time, the method proceeds from 412 to 406, and then back to 400.

If, however, the aircraft 104 will be proximate to the in-flight hazard at the future time, the method proceeds from 412 to 414, at which the rerouting control unit 108 determines one or more reroute options having one or more clearpoints. At 416, the rerouting control unit 108 determines if the one or more reroute options conflict with a flight path of one or more other aircraft within the airspace 106, as determined by the tracking system 118, for example. If a reroute option does conflict with the flight path of another aircraft within the airspace 106, the rerouting control unit 108 discards such reroute option (for example, does not include it as a reroute option, nor does it show it on a monitor or user interface), and the method returns to 414.

If, however, the determined reroute option does not conflict with the flight path of one or more other aircraft at 416, the method proceeds to 420, at which the rerouting control unit 108 determines if the reroute option results in the aircraft 104 having sufficient fuel and weight (for example, meets minimum fuel and weight requirements) at the destination location. If not, the method proceeds to 418, at which the reroute option is discarded, and the method returns to 414. If, however, the reroute option, as determined by the rerouting control unit 108, leads to a predicted fuel and weight of the aircraft 104 being sufficient at the destination location, the method proceeds from 420 to 422, at which the rerouting control unit 108 displays the reroute option(s), such as on one or both of the monitor 110 and/or the user interface 141. At 424, a pilot then selects a reroute option, as determined and shown by the rerouting control unit 108. At 426, the flight plan is adapted (for example, changed) based on the selected reroute option, such as is chosen by a pilot. At 428, the rerouting control unit 108 determines if the aircraft 104 has landed at the destination location. If so, the method ends at 430. If the aircraft 104 has not yet landed, the method returns to 400.

Optionally, step 420 can occur before step 416. As another example, steps 416 and 420 can occur simultaneously.

In at least one example, all or part of the systems and methods described herein may be or otherwise include an artificial intelligence (AI) or machine-learning system that can automatically perform the operations of the methods also described herein. For example, the rerouting control unit 108 can be an artificial intelligence or machine learning system. These types of systems may be trained from outside information and/or self-trained to repeatedly improve the accuracy with how samples are analyzed in relation to standards. Over time, these systems can improve by determining reroute options with increasing accuracy and speed, thereby significantly reducing the likelihood of any potential errors. The AI or machine-learning systems described herein may include technologies enabled by adaptive predictive power and that exhibit at least some degree of autonomous learning to automate and/or enhance pattern detection (for example, recognizing irregularities or regularities in data), customization (for example, generating or modifying rules to optimize record matching), or the like. The systems may be trained and re-trained using feedback from one or more prior analyses of flight paths, reroute options, and/or other such data. Based on this feedback, the systems may be trained by adjusting one or more parameters, weights, rules, criteria, or the like, used in the analysis of the same. This process can be performed using flight path and reroute data instead of training data, and may be repeated many times to repeatedly improve the determination of reroute options. The training of the record matching system minimizes conflicts and interference with other flight paths by performing an iterative training algorithm, in which the systems are retrained with an updated set of data and based on the feedback examined prior to the most recent training of the systems. This provides a robust analysis model that can better determine whether reroute options are viable, accurate, efficient, and the like.

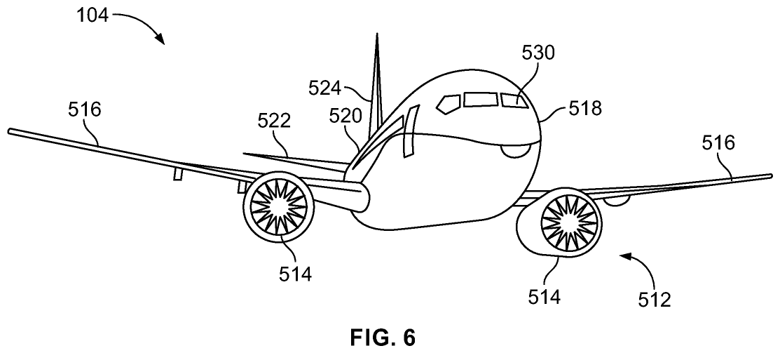

FIG. 6 is a diagrammatic representation of a front perspective view of an aircraft 104, according to an exemplary embodiment of the present disclosure. The aircraft 104 includes a propulsion system 512 that can include two turbofan engines 514, for example. Optionally, the propulsion system 512 can include more engines 514 than shown. The engines 514 are carried by wings 516 of the aircraft 104. In other examples, the engines 514 can be carried by a fuselage 518 and/or an empennage 520. The empennage 520 can also support horizontal stabilizers 522 and a vertical stabilizer 524. The fuselage 518 of the aircraft 104 defines an internal cabin, which may include a cockpit 530 that includes the flight computer 116 (shown in FIG. 1), for example. Further, the flight plan diversion prediction system 100 (shown in FIG. 1) may be within the cockpit 530.

The aircraft 104 may be sized, shaped, and configured other than shown in FIG. 6. For example, the aircraft 104 may be a non-fixed wing aircraft, such as a helicopter. As another example, the aircraft 104 can be an unmanned aerial vehicle (UAV).

Referring to FIGS. 1-6, examples of the present disclosure provide systems and methods that allow large amounts of data to be quickly and efficiently analyzed by a computing device. For example, numerous aircraft 104 may be scheduled to fly within the airspace 106. As such, large amounts of data are being tracked and analyzed. The vast amounts of data are efficiently organized and/or analyzed by the rerouting control unit 108, as described herein. The rerouting control unit 108 analyzes the data in a relatively short time in order to quickly and efficiently output and/or display reroute information for the aircraft 104. For example, the rerouting control unit 108 analyzes current locations of the aircraft 104 and in-flight hazards in real or near real time to determine reroute options for one or more of the aircraft 104 based on predicted positions of the aircraft 104 and the in-flight hazards at future times. A human being would be incapable of efficiently analyzing such vast amounts of data in such a short time. As such, examples of the present disclosure provide increased and efficient functionality with respect to prior computing systems, and vastly superior performance in relation to a human being analyzing the vast amounts of data. In short, examples of the present disclosure provide systems and methods that analyze thousands, if not millions, of calculations and computations that a human being is incapable of efficiently, effectively and accurately managing.

Further, the disclosure comprises examples according to the following clauses:

Clause 1. A system comprising:
a rerouting control unit configured to generate one or more reroute options for an aircraft based on an analysis of a current position of the aircraft, a predicted future position of the aircraft, a current position of an in-flight hazard, a predicted future position of the in-flight hazard, and one or both of: (i) a flight path of one or more other aircraft within an airspace, or (ii) one or both of a minimum amount of fuel of the aircraft or a minimum weight of the aircraft at a destination location.

Clause 2. The system of Clause 1, wherein the rerouting control unit is configured to generate the one or more reroute options for the aircraft based on the analysis of the current position of the aircraft, the predicted future position of the aircraft, the current position of the in-flight hazard, the predicted future position of the in-flight hazard, and both of: (i) the flight path of one or more other aircraft within the airspace, and (ii) one or both of the minimum amount of fuel of the aircraft or the minimum weight of the aircraft at the destination location.

Clause 3. The system of Clauses 1 or 2, wherein the rerouting control unit is configured to generate the one or more reroute options for the aircraft based on the analysis of the current position of the aircraft, the predicted future position of the aircraft, the current position of the in-flight hazard, the predicted future position of the in-flight hazard, and both of: (i) the flight path of one or more other aircraft within the airspace, and (ii) both of the minimum amount of fuel of the aircraft and the minimum weight of the aircraft at the destination location.

Clause 4. The system of any of Clauses 1-3, wherein the rerouting control unit determines that each of the one or more reroute options does not interfere with the flight path of the one or more other aircraft within the airspace.

Clause 5. The system of any of Clauses 1-4, wherein the in-flight hazard is one or more of a weather cell as tracked by a weather tracking sub-system in communication with the rerouting control unit, air turbulence as tracked by an air turbulence tracking sub-system in communication with the rerouting control unit, or restricted airspace as tracked by a restricted airspace tracking sub-system in communication with the rerouting control unit.

Clause 6. The system of any of Clauses 1-5, further comprising a user interface onboard the aircraft, wherein the rerouting control unit is configured to show the one or more reroute options on the user interface to allow a pilot to select the one or more reroute options.

Clause 7. The system of any of Clauses 1-6, wherein the aircraft is configured to be automatically operated according to a selected one of the one or more reroute options.

Clause 8. The system of any of Clauses 1-7, wherein the one or more reroute options include a plurality of reroute options.

Clause 9. The system of Clause 8, wherein the plurality of reroute options comprises at least two of a turbulence avoidance reroute option, a severe weather avoidance reroute option, a shortest time to destination reroute option, and a least fuel burn reroute option.

Clause 10. The system of Clauses 8 or 9, wherein the rerouting control unit is configured to assess each of the plurality of reroute options in relation to each of the other of the plurality of reroute options.

Clause 11. The system of any of Clauses 1-10, wherein the rerouting control unit 108 is or is part of an artificial intelligence or machine learning system.

Clause 12. A method comprising:
generating, by a rerouting control unit, one or more reroute options for an aircraft based on an analysis of a current position of the aircraft, a predicted future position of the aircraft, a current position of an in-flight hazard, a predicted future position of the in-flight hazard, and one or both of: (i) a flight path of one or more other aircraft within an airspace, or (ii) one or both of a minimum amount of fuel of the aircraft or a minimum weight of the aircraft at a destination location.

Clause 13. The method of Clause 12, wherein said generating comprises generating the one or more reroute options for the aircraft based on the analysis of the current position of the aircraft, the predicted future position of the aircraft, the current position of the in-flight hazard, the predicted future position of the in-flight hazard, and both of: (i) the flight path of one or more other aircraft within the airspace, and (ii) one or both of the minimum amount of fuel of the aircraft or the minimum weight of the aircraft at the destination location.

Clause 14. The method of Clauses 12 or 13, wherein said generating comprises generating the one or more reroute options for the aircraft based on the analysis of the current position of the aircraft, the predicted future position of the aircraft, the current position of the in-flight hazard, the predicted future position of the in-flight hazard, and both of: (i) the flight path of one or more other aircraft within the airspace, and (ii) both of the minimum amount of fuel of the aircraft and the minimum weight of the aircraft at the destination location.

Clause 15. The method of any of Clauses 12-14, wherein said generating comprises determining, by the rerouting control unit, that each of the one or more reroute options does not interfere with the flight path of the one or more other aircraft within the airspace.

Clause 16. The method of any of Clauses 12-15, wherein the in-flight hazard is one or more of a weather cell as tracked by a weather tracking sub-system in communication with the rerouting control unit, air turbulence as tracked by an air turbulence tracking sub-system in communication with the rerouting control unit, or restricted airspace as tracked by a restricted airspace tracking sub-system in communication with the rerouting control unit.

Clause 17. The method of any of Clauses 12-16, further showing, on a user interface onboard the aircraft by the rerouting control unit, the one or more reroute options on the user interface to allow a pilot to select the one or more reroute options.

Clause 18. The method of any of Clauses 12-17, further comprising automatically operating the aircraft according to a selected one of the one or more reroute options.

Clause 19. The method of any of Clauses 12-18, wherein the one or more reroute options include a plurality of reroute options, wherein the plurality of reroute options comprises a turbulence avoidance reroute option, a severe weather avoidance reroute option, a shortest time to destination reroute option, and a least fuel burn reroute option.

Clause 20. The method of Clause 19, wherein said generating comprises assessing, by the rerouting control unit, each of the plurality of reroute options in relation to each of the other of the plurality of reroute options.

As described herein, examples of the present disclosure provide systems and methods of accurately predicting and communicating various flight path aspects of an aircraft. Further, examples of the present disclosure provide systems and methods of allowing a pilot to assess how much fuel an aircraft will have at a destination before and/or after diverting from a flight plan. Moreover, examples of the present disclosure provide systems and methods that provide flight plan and/or flight path diversion options to a pilot.

While various spatial and directional terms, such as top, bottom, lower, mid, lateral, horizontal, vertical, front and the like can be used to describe examples of the present disclosure, it is understood that such terms are merely used with respect to the orientations shown in the drawings. The orientations can be inverted, rotated, or otherwise changed, such that an upper portion is a lower portion, and vice versa, horizontal becomes vertical, and the like.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

It is to be understood that the above description is intended to be illustrative, and not restrictive. For example, the above-described examples (and/or aspects thereof) can be used in combination with each other. In addition, many modifications can be made to adapt a particular situation or material to the teachings of the various examples of the disclosure without departing from their scope. While the dimensions and types of materials described herein are intended to define the parameters of the various examples of the disclosure, the examples are by no means limiting and are exemplary examples. Many other examples will be apparent to those of skill in the art upon reviewing the above description. The scope of the various examples of the disclosure should, therefore, be determined with reference to the appended claims, along with the full scope of equivalents to which such claims are entitled. In the appended claims and the detailed description herein, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose the various examples of the disclosure, including the best mode, and also to enable any person skilled in the art to practice the various examples of the disclosure, including making and using any devices or systems and performing any incorporated methods. The patentable scope of the various examples of the disclosure is defined by the claims, and can include other examples that occur to those skilled in the art. Such other examples are intended to be within the scope of the claims if the examples have structural elements that do not differ from the literal language of the claims, or if the examples include equivalent structural elements with insubstantial differences from the literal language of the claims.

What is claimed is:

1. A system comprising:
a rerouting control unit configured to generate one or more reroute options for an aircraft based on an analysis of a current position of the aircraft, a predicted future position of the aircraft, a current position of an in-flight hazard, a predicted future position of the in-flight hazard, and one or both of: (i) a flight path of one or more other aircraft within an airspace, or (ii) one or both of a minimum amount of fuel of the aircraft or a minimum weight of the aircraft at a destination location.

2. The system of claim 1, wherein the rerouting control unit is configured to generate the one or more reroute options for the aircraft based on the analysis of the current position of the aircraft, the predicted future position of the aircraft, the current position of the in-flight hazard, the predicted future position of the in-flight hazard, and both of: (i) the flight path of one or more other aircraft within the airspace, and (ii) one or both of the minimum amount of fuel of the aircraft or the minimum weight of the aircraft at the destination location.

3. The system of claim 1, wherein the rerouting control unit is configured to generate the one or more reroute options for the aircraft based on the analysis of the current position of the aircraft, the predicted future position of the aircraft, the current position of the in-flight hazard, the predicted future position of the in-flight hazard, and both of: (i) the flight path of one or more other aircraft within the airspace, and (ii) both of the minimum amount of fuel of the aircraft and the minimum weight of the aircraft at the destination location.

4. The system of claim 1, wherein the rerouting control unit determines that each of the one or more reroute options does not interfere with the flight path of the one or more other aircraft within the airspace.

5. The system of claim 1, wherein the in-flight hazard is one or more of a weather cell as tracked by a weather tracking sub-system in communication with the rerouting control unit, air turbulence as tracked by an air turbulence tracking sub-system in communication with the rerouting control unit, or restricted airspace as tracked by a restricted airspace tracking sub-system in communication with the rerouting control unit.

6. The system of claim 1, further comprising a user interface onboard the aircraft, wherein the rerouting control unit is configured to show the one or more reroute options on the user interface to allow a pilot to select the one or more reroute options.

7. The system of claim 1, wherein the aircraft is configured to be automatically operated according to a selected one of the one or more reroute options.

8. The system of claim 1, wherein the one or more reroute options include a plurality of reroute options.

9. The system of claim 8, wherein the plurality of reroute options comprises at least two of a turbulence avoidance reroute option, a severe weather avoidance reroute option, a shortest time to destination reroute option, and a least fuel burn reroute option.

10. The system of claim 8, wherein the rerouting control unit is configured to assess each of the plurality of reroute options in relation to each of the other of the plurality of reroute options.

11. The system of claim 1, wherein the rerouting control unit is or is part of an artificial intelligence or machine learning system.

12. A method comprising:
generating, by a rerouting control unit, one or more reroute options for an aircraft based on an analysis of a current position of the aircraft, a predicted future position of the aircraft, a current position of an in-flight hazard, a predicted future position of the in-flight hazard, and one or both of: (i) a flight path of one or more other aircraft within an airspace, or (ii) one or both of a minimum amount of fuel of the aircraft or a minimum weight of the aircraft at a destination location.

13. The method of claim 12, wherein said generating comprises generating the one or more reroute options for the aircraft based on the analysis of the current position of the aircraft, the predicted future position of the aircraft, the current position of the in-flight hazard, the predicted future position of the in-flight hazard, and both of: (i) the flight path of one or more other aircraft within the airspace, and (ii) one or both of the minimum amount of fuel of the aircraft or the minimum weight of the aircraft at the destination location.

14. The method of claim 12, wherein said generating comprises generating the one or more reroute options for the aircraft based on the analysis of the current position of the aircraft, the predicted future position of the aircraft, the current position of the in-flight hazard, the predicted future position of the in-flight hazard, and both of: (i) the flight path of one or more other aircraft within the airspace, and (ii) both of the minimum amount of fuel of the aircraft and the minimum weight of the aircraft at the destination location.

15. The method of claim 12, wherein said generating comprises determining, by the rerouting control unit, that each of the one or more reroute options does not interfere with the flight path of the one or more other aircraft within the airspace.

16. The method of claim 12, wherein the in-flight hazard is one or more of a weather cell as tracked by a weather tracking sub-system in communication with the rerouting control unit, air turbulence as tracked by an air turbulence tracking sub-system in communication with the rerouting control unit, or restricted airspace as tracked by a restricted airspace tracking sub-system in communication with the rerouting control unit.

17. The method of claim 12, further showing, on a user interface onboard the aircraft by the rerouting control unit, the one or more reroute options on the user interface to allow a pilot to select the one or more reroute options.

18. The method of claim 12, further comprising automatically operating the aircraft according to a selected one of the one or more reroute options.

19. The method of claim 12, wherein the one or more reroute options include a plurality of reroute options, wherein the plurality of reroute options comprises a turbulence avoidance reroute option, a severe weather avoidance reroute option, a shortest time to destination reroute option, and a least fuel burn reroute option.

20. The method of claim 19, wherein said generating comprises assessing, by the rerouting control unit, each of the plurality of reroute options in relation to each of the other of the plurality of reroute options.
